(19) United States
(12) Patent Application Publication
(10) Pub. No.: US 2012/0302462 A1
(43) Pub. Date: Nov. 29, 2012

(54) System and Method for Detecting and Quantifying Active T-cells or Natural Killer Cells

(76) Inventors: Bjorn Onfelt, Bromma (SE); Michael Uhlin, Falun (SE); Klas Karre, Stockholm (SE); Bruno Vanherberghen, Enskede (SE); Thomas Frisk, Ingaro (SE)

(21) Appl. No.: 13/508,581

(22) PCT Filed: Nov. 9, 2010
(86) PCT No.: PCT/EP2010/067077

§ 371 Date: Jul. 23, 2012

Related U.S. Application Data
(60) Provisional application No. 61/280,809, filed on Nov. 9, 2009.

(51) Int. Cl. C40B 30/06; C40B 60/12

(52) U.S. Cl. 506/10; 506/39

(57) ABSTRACT

A system and a methodology are provided with a broad range of application in immune diagnostic screening and therapy and specifically for predicting the risk of graft versus host disease (GVHD) and/or graft versus leukemia (GVL) effects prior to transplantation. The method includes the steps of incubating single T or NK cells with a few, usually three to five target cells for extended period of times and evaluating the cell contact-dependent lytic activity or activation of the single effector cells within larger populations. The results obtained are analyzed by proprietary software for automated image analysis and compared with patient data comprised in a comprehensive database containing accumulated empirical and clinical information on donor-recipient screening results and patient information. A micro device is provided for implementing the disclosed method, wherein said micro device is a multi-well microchip, having tens of thousands wells with defined characteristics thus allowing long-term assays and quantitative cell activity inspection/evaluation by high-resolution microscopy.

### CROSS-REFERENCE TO RELATED APPLICATIONS

This application claims priority from PCT/EP2010/067077 filed Nov. 9, 2010, which claims priority from U.S. Provisional Application Ser. No. 61/280,809 filed Nov. 9, 2009.

### BACKGROUND OF THE INVENTION

1. Field of the Invention

The present invention concerns a novel combination of unique tools for improved cellular resolution in investigating functional properties of cell populations. In particular, the invention herein is a system and a methodology for detecting, isolating and/or quantifying specific active effector cells within larger populations based on interaction with pre-determined desired target cells. In particular embodiments the reactivity on a single cell level and specifically the lytic activity of a single effector cell is used as basis for evaluating the population general specificity towards the target cells.

More specifically, the present invention relates to the prediction of the risk of graft versus host disease (GVHD) and/or graft versus leukemia (GVL) effects prior to transplantation. The primary purpose of the invention is to increase the long-term success rate of allogeneic stem cell transplantation (SCT) by providing physicians with a quantitative and sensitive prognostic test aimed at minimizing health complications, relapse and patient mortality after SCT.

2. Description of the Related Art

Stem cell transplantation (SCT) is an important therapy in treatment of leukemia and metabolic disorders. SCT is commonly performed in order to restore essential immune function after chemotherapy and radiation since this, besides desired anti-tumor effects, often causes destruction of the patient's hematopoietic system, leading to loss of essential immune function.

By allogeneic SCT of bone marrow-derived stem cells, immune function can be restored. However, even though stem cell donors are selected based on matching human leukocyte antigen (HLA), complications regularly occur where transplanted cells perceive the recipient's cells as foreign, leading to a patient-directed immune response and GVHD. This deadly complication is mainly caused by cytotoxic T cells (CTL) with specificity for antigens derived from the patient.

Symptoms of GVHD are treated with expensive immuno-suppressive therapies, with increased susceptibility to infections as a consequence. Thus, immuno-suppressants are undesirable to use both considering patient health and the high cost to society. For patients with malignant disease, a low grade of GVHD is beneficial since it is often associated with CTL or natural killer (NK) cell mediated GVL leading to increased long-term survival. However, severe GVHD is associated with high mortality rates, large treatment costs and socioeconomic effects. Unfortunately, there are no reliable methods for predicting the risk of GVHD or chance of GVL prior to selection of donors for SCT.

One reason why prognosis of GVHD and GVL is not trivial is that an individual's repertoire of NK and T cells (hereafter collectively called effector cells) is heterogeneous and immune responses such as GVHD or GVL following SCT or autoimmunity can be caused by a small number of cells, or even individual cells. This makes the detection impossible by conventional experimental methods based on bulk populations of cells.

Therefore, it can be appreciated that it is of upmost importance to have methods that can detect and quantify the number of effector cells that are activated, for example, by recognition of certain target cells, certain antigen or soluble or plate-bound factors such as cytokines or monoclonal antibodies. Furthermore, it is of great interest to have methods for selecting donors for stem cell transplantation based on prognosis of T cell mediated GVHD and T cell or NK cell mediated GVL effects and methods for isolating such effector cells that could be used in adoptive immune therapy to treat malignancies or severe viral infections.

Single cell analysis is presently performed using two main approaches: flow cytometry and macroscopic well arrays where homogenous, clonal populations are assumed to behave as single cells. Flow cytometry is a powerful tool to distinguish and sort different cell types and subpopulations of cells based on size and expression of specific proteins subsequent to antibody labeling. Nevertheless, this technique has many drawbacks, as it does not allow multiple readings of the same cell through time making it unsuitable for investigations of dynamic cell-cell interactions.

In recent years there has been a tremendous development of micro devices fabricated for applications in cell biology. This includes devices and structured surfaces for studies of single cells or small number of cells (1).

In this regard, one particular challenge has been to develop devices for studies of non-adherent cells. Such devices are needed since it is difficult to retain such cells at a given location during periods of manipulation, incubation and read-out, for example. The read-out of single cell assays in micro devices is often based on optical microscopy.

One method to trap non-adherent cells is dielectrophoresis (DEP) where individual cells are captured and held in place by an electric field gradient (2-3) These devices require that one electrode is fabricated, for example on a chip of silicon or glass, for each trapping site.

US patent publication 2005/0014201 discloses an individual cells biochip processor device with optical transparent wells for measuring the activity or manipulating a single individual living cell. The microchip has 150 micron sized hexagonal wells that would not limit cell movement upon suspension in culture media if it were not for the presence of one or more microelectrodes for handling and maintaining the cells inside the wells. The presence of electrodes enables electromagnetic manipulation of the cells and although it makes every trapping site individually addressable, it severely limits the number of cells that can be trapped on a given area. The shallow design of the wells, the presence of channels in between the wells and the use of induced exterior forces make it difficult if not impossible to carry out long-term, assays and study cellular interaction, in the way disclosed in the present invention.

In addition, there are several examples of devices where cells are trapped against physical objects (4) or holes by hydrodynamic forces (5-6). A drawback with the hydrodynamic forces trapping methods is that the liquid pressure strain induced on the cell and the liquid flow induced surface stress is likely to affect the cells in an assay. Another drawback with this trapping method is the limitation on the cells' natural movements, thus limiting the interaction or limiting multiple interaction events. Furthermore, this method usually involves the use of pumps or other pressure sources, as well as fluidic connections, hermetic sealing, flow and pressure control systems, etc. In the case of cell interaction studies involving imaging analysis, it has to be noted that pressure or flow fluctuations often have an impact on image quality, as these fluctuations will cause the images to be blurry or out of focus.

To avoid the aforementioned drawbacks, the inventors herein used a non-invasive method for trapping cells, namely, sedimentation, by which cells are let to sediment into microwells made by etching in glass or silicon, or template molding in polydimethylsiloxane (PDMS) or plastic (7).

As previously stated, the number of micro devices recently developed for monitoring single or low numbers of cells in an array format has increased considerably, resulting in a wide variation of function and design of new devices.

U.S. Pat. No. 6,025,129, for example, teaches a method of recording treatment steps that a particle such as a cell has undergone. In this method one or more cells are held in the wells of a matrix associated to an electrical memory. Another patent also related to micro devices for studying single cell function is U.S. Pat. No. 5,506,141 describing an electroplating technique based on the use of an apertured cell carrier containing individual living cells (one cell per aperture). The problem with this patent is that there is little mobility for the tightly trapped living cell in each cell carrier and this impedes any mechanical manipulation of the cell, including its extraction. The cell immobilization functionality is thus dependant on the geometrical features of the well. This is not suitable for two cell interaction assays, as the wells fit only one cell. Enlarging the well to fit two cells with different geometry will not work, as the smaller cell will escape. US patent application publication 2008/0014631 teaches a microwell array chip having multiple and up to 10,000 microwells on a principal surface of a substrate. The microwells are of a shape and size to permit the storage of only a single organic cell in each microwell. The size of the wells limits the volume of culture media contained in each well and thereby the availability of nutrients. As a consequence, cell interaction studies and long-term assays are not possible with this kind of device. For devices specifically designed to hold a single cell per well and in the cases when the outcome of a long-term assay has to be inspected with high resolution imaging the use of a dipping lens, which will induce liquid movements, cell movements and cell escape from the well, might be required. While the aforementioned devices have been designed for single cell confinement, the device and system of the present invention aim to study cell to cell interactions on a large scale.

Moreover with the prior devices, even in those cases in which more than one individual cell can be held in a well or compartment, it is not possible to control exactly how many cells end up in each well. To overcome the aforementioned shortcomings, the inventors herein have designed and produced a microchip consisting of tens of thousands of miniature wells where low numbers of different cells can be confined and allowed to interact. For this purpose the loading conditions has been stochastically optimized in order to get as many wells as possible containing single effector cells surrounded by a few (typically three to five) target cells. The invention has been fabricated to have biocompatible deep etched, steep walled wells that can fit up to 20 cells, and allows cell proliferation for periods extending from a few hours to a few weeks. This proliferation facilitates subsequent isolation of clonal populations of the activated effector cells from the wells.

In general, the principle is to incubate single effector cells with a few target cells in each well and evaluate the lytic activity of the effector cells in a large population of cells. However, embodiments with several effector cells in each well, as well as other criteria beside cell lysis for evaluating effector cell activation are also part of the present invention.

Currently, the lytic activity of populations of effector cells can be measured by various cytolysis assays that determine the amount of target cell death induced (8). Population based assays include radioactivity (e.g. chromium, methionine, thymidine) or fluorescence (e.g. europium, Eu-TDA, calcein-AM) release assays while assays with single cell resolution comprise flow cytometric based tools measuring target cell death or caspase activation within target cells (9-11). Importantly, the latter methods assess target cell death with single cell resolution but do not provide information on the single cell level for the effector cell population. Other methods include Western Blot, ELIspot and PCR for activation of gene expression (12-17); however, these methods require that cells are lysed. The benefit of the disclosed invention is that it measures cytotoxic activity based on direct cell-cell interaction and, thus, is independent of mechanism of killing, a priori knowledge of protein markers or antigen.

WO07/1 16309 describes a method based on the use of effector cells selected for being able to induce lysis in target cells. The method is particular useful in the diagnosis and/or prognosis of the disease state of a neoplastic patient. It is based on the real time monitoring and quantification of the lytic effectiveness at a level of single cell. Lysis kinetics in the effector cells/target cell aggregate is assessed during very short periods of time varying from 8 to 20 minutes. The system and methodology described in the present application relies on the possibility of incubating a population of effector cells, at individual cell level, together with target cells in confined volumes for extended periods of time (often several hours or days) without the risk of material-induced cytotoxicity or cross-talk, e.g. cells migrating between confined volumes. Long incubation times are a key factor in the invention herein in order to evaluate and quantify the aggressiveness towards the target cells. For predicting chance of GVL prior to selection of donors a high aggressiveness of the effector cells against the tumor cells of the patient (recipient) is desired, while for predicting the risk of GVHD a low aggressiveness against the patients normal cells is preferred. Other important differences between the aforementioned patent and the method of the invention can be summarized as follow. The loading method differs remarkably as the lytic activity assay involves contacting three effector cells with a single target cell instead of a single effector cell with several target cells as in the present invention. The cited patent relies on the use of a lab-on-chip device based on an extensive use of dielectrophoresis, which in addition to the disadvantages already discussed, could be considered to force cell-cell interaction. This patent utilizes pre-selected effector cells, while the invention herein utilizes bulk cultures of effector cells. It is also the case that high-throughput screening for analyzing significant populations of cells might not be achievable in the method described in patent WO07/116309.

Taking into consideration the above-listed shortcomings, it is an object of the present invention to provide novel methods in which the lytic activity of a single effector cell is used as the basis for evaluating the population general specificity towards specific target cells.

In addition, it is a further object of the invention to provide a system comprising a specially designed multi-well micro device, a software program for automated image analysis and accumulated database acquisition. The data generated by the software program for optical analyses is compared with patient data stored in the accumulated database containing empirical and statistical information on clinical outcome, Thus, the invention provides a new level of quantification of effector cell activity.

We believe it is the first time an empirical, instead of an analytical approach, has been proposed to solve the problem of GVHD and/or predict the chances for GVL with a given patient-donor matching. Accordingly, the present invention provides a previously unprecedented level of prediction of donor/patient compatibility, where many cases of GVHD can be completely avoided, or if no perfectly matched donors are available, the type and level of preventive care can be tailored for each patient. Thus, by combining, simplicity, robustness and low cost, survival of patients undergoing SCT would be increased. With no reliable alternative methods for predicting GVHD/GVL today, our screening method has potential for becoming a standard procedure in SCT clinics.

In these respects, the present invention substantially departs from conventional concepts and designs of the prior art, and in doing so has succeeded in providing products and methods for improved cellular resolution in investigating functional properties of cell populations that can be used, e.g. for prediction of GVHD/GVL effects in SCT, in evaluating the effect of specific drugs, in vaccine development or for studying effector cell involvement in autoimmune diseases.

### SUMMARY OF THE INVENTION

The general purpose of the present invention is to provide a system and a methodology for predicting the risk of GVHD or the chance of GVL effects for potential donors with patients that are to undergo SCT. In this regard, the invention discloses products and methods for detecting, isolating and/or quantifying specific active effector cells within larger populations.

In particular, the reactivity on a single cell level and specifically the lytic activity of a single effector cell is used as basis for evaluating the population general specificity towards specific target cells. To attain this, the inventors herein have designed and developed a system comprising (a) a multi-well microchip consisting of tens of thousands of miniature wells, where single effector cells and a few, e.g. three to five but could be more, target cells are allowed to interact for periods extending to several days; (b) a software program for automated image analysis, by which the numbers of live and dead target cells, as well as the number of effector cells, are evaluated in each well; and (c) an accumulated database containing empirical and clinical information on donor-recipient screening results, patient survival and clinical outcome.

By comparing the data generated by the software for optical analyses with patient data stored in the accumulated database the system hereby disclosed provides a novel empirical approach for predicting GVHD-GVL after SCT. Since the number of SCT to patients in need thereof is limited due to the risk of GVHD, a reliable prediction method would have great advantages.

The invention herein is not limited to the prediction of the risk of GVHD or GVL effects prior to SCT instead it finds wide applicability in e.g. cell therapy, adoptive immune therapy, treatment of malignancies or severe viral infections, in vaccine development, and the like.

Other objects and advantages of the present invention will become obvious to the reader and it is intended that these objects and advantages be within the scope of the present invention. There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it:is to be understood that the phraseology and terminology employed herein are for the purpose of the description and should not be regarded as limiting.

### BRIEF DESCRIPTION OF THE DRAWINGS

The foregoing summary, as well as the following detailed description of the invention, will be better understood when read in conjunction with the appended drawings. It should be understood, however, that the invention is not limited to the precise arrangements and instrumentalities shown.

FIG. 1 illustrates the automated detection and screening of effector cells, all target cells and living target cells.

FIG. 2 is a flow-chart depicting the process for image analysis.

FIG. 3 is a schematic representation of the process for predicting GVHD/GVL outcome by the use of the accumulated database with clinical and empirical data.

FIG. 4 is a partial schematic diagram illustrating a potential embodiment of a design of the microchip.

FIG. 5 shows the sequence of steps in three different methods for the manufacture of silicon-glass microchips: A. Photolithography. B. Deep etching. C. Anodic bonding.

### DETAILED DESCRIPTION OF THE INVENTION AND PREFERRED EMBODIMENTS THEREOF

Acute Graft-Versus-Host-Disease (GVHD) is a significant problem in allogeneic stem cell transplants (ASCT) but no clear test is currently available for prediction of GVHD prior to transplantation. The disclosed invention provides a prognostic test for improving patient-donor matching so as to minimize the GVHD complication, ultimately increasing the success rate of ASCT. The invention concerns a method and a system for predicting GVHD or GVL effects.

The general purpose of the present invention, which will be described subsequently in greater detail, is to provide a method for assessing the number of effector cells of certain specificity within larger cell populations by using a microdevice and optical microscopy screening. The present invention relates to the detection of single, alloreactive donor cells in a large population before allotransplantation, as well as autologous donor cells before autotransplantation. Discrete cell interactions between donor effector cells and patient target cells are separated and observed so that to quantitatively measure the outcome of said interaction. Thus, at the root of the invention is the assessment of the cell contact-dependent lytic activity or activation of individual effector cells, e.g. T or NK cells, within larger populations. Inactive effector cells, recently isolated or stimulated with IL-2 or IL-15, are incubated with target cells, and the effector cells that show reactivity towards the target cells, or become active or activated after contact with target cells, could be evaluated as a way of assessing and quantifying activity or activation of effector cells towards specific target cells. The term “activated effector cells” shall be construed as meaning effector cells from a donor that show activity due to their interaction with target cells from a recipient.

Other methods for evaluating or measuring effector cell activation besides cell lysis can be by assessing their upregulation of activation markers, such as CD69, CD25, CD71, 4_{—}1BB or CD24, or upregulation of cytokines, such as IFN-γ, IL-12, IL-17 or TNF-α. The determination of stable cell-cell contacts between effector and target, e.g. indicated by formation of immune synapses and clustering of specific proteins at the intercellular contact, may be another way of evaluating activation, as well as proliferation (clonal expansion) of the effector cell, e.g. CD4+ T-cells. To attain this, single effector cells are incubated for an extended period with a few, usually three to five, target cells and the activation (lytic activity, upregulation of activation markers or cytokines, stable cell-cell contact or proliferation) of the effector cells is evaluated. Several effector cells may also be used in each well, and the number of target cells may vary from 2 up to 20 or more, for example 3, 4, 5, 6, 7, 8, 9, 10, 11, 12, 13, 14, 15, 16, 17, 18, 19, 20 or more. There might be 1-50 target cells in one well, preferably 1-15, most preferably 1-5. Target cells may be tumor cells (leukemic cancer cells) for the GVL application, or a cocktail of representative cells from the patient in the GVHD application. The method and system are used as decision support for a physician, answering questions like which donor is optimal to choose, if it is a feasible risk at all, or if we can expect a GVHD reaction and therefore should use preventive medication. This last aspect could also be considered when transplanting organs, such as kidneys, since GVHD treatment is best done in advance before the break out because it is difficult to combat once it has broken out, and preventive treatment without an indicated risk is avoided due to severe side effects and expensive medication. The reverse situation may also be predicted when transplanting organs, the risk of host versus graft and transplant rejection, and the result may be used to select between donors.

### 1. The Method

An object of the present invention is to detect activation of effector cells, i.e. effector cells such as T-cells and NK-cells which have been activated by target cells in a well, niche, compartment or cell chamber in a micro device containing several such wells or compartments, on a single cell level. The present method can detect low frequencies of active cells, much lower than a population experiment may do in comparison to the background.

The present invention concerns a method to detect specifically activated effector functions of immune cells (effector cells) in microwells or cell chambers at a single cell level/resolution (on individual cells) by e.g. fluorescence microscopy, bright field, radioactivity or other suitable detection method. The method concerns detecting activated/activity of effector cells from a donor towards specific targets cells of a recipient, i.e. effector cells that get activated by co-incubation with said specific target cells. The method comprises:
a. Isolation/preparation of effector and target cells from donor and recipient, e.g. by density gradient separation and/or antibody separation based on surface-markers.
b. Distributing these cells in to cell chambers or microwells able to contain and maintain them viable, preferably one effector cell per well/chamber and a few target cells, such as two, three, four, five, six, seven or more target cells, typically three to five. Preferably, the target cells are distributed first then the effector cells
c. Incubating the cells for a few hours up to several days, preferably 4-48 hours
d. Measuring/evaluating effector function of specific single effector cells by e.g. microscopy screening and image analysis

The cells may be labeled by e.g. fluorescence before distribution into the wells or chambers or after incubation. In the case where the cells are not labeled, markers secreted from the cell, e.g. cytokines may be labeled instead. An optimized staining protocol to minimize side effects on target and effector cells, with possible different staining procedures for different cell types, may be used. The detection in step d may be using optical microscopy, such as bright-field, fluorescence microscopy, bioluminescence or different optical plate readers, radioactivity or scanning probe.

The effector functions that can be measured/detected to evaluate effector cell activation are the lysis (killing) of target cells, the upregulation of activation markers or cytokines, stable cell-cell contacts between effector cell and target indicated by e.g. formation of immune synapses and clustering of specific proteins at the intercellular contact or the proliferation of the effector cell.

The invention further concerns a method for quantifying/assessing the number of active effector cells within larger cell populations, by counting active effector cells detected using the method described above. Through image analysis the number of active cells is determined. More details about the image analysis are disclosed in the experimental section, example 1.6.

The results from the above-mentioned method are then used to predict the risk of GVHD (target cells are normal cells) and/or the chance of GVL effects (target cells are tumor cells or normal cells). The prediction is based upon a database containing information about patients and donors from earlier transplantations and the outcome of GVHD or GVL effects for said transplantations. The patient and donor materials are evaluated using the method, and the results regarding level of activation of the donor cells toward the target cells are added to the database. A correlation between activation level in the assay and actual outcome regarding GVHD/GVL may then be established. This correlation may be used to predict GVHD/GVL before transplantation, by comparing the patient and donor information and the level of activation to known situations in the database. A statistical “cut off” value may be calculated, the border-value in the activation assay between a low or high risk transplantation regarding GVHD or GVL. The database and the empirical analysis are described in further detail in the experimental section, example 1.7.

The method can also be used for determining ongoing GVHD after transplantation, the patient may have diffuse symptoms of an ongoing GVHD, such as stomachache or bleedings, and the method will confirm this. For example, lymphocytes may be isolated from the intestines of the patient and tested against the patient's own cells, e.g. fibroblasts.

The results of the method may be used to select appropriate donors for a selected patient before transplantation, to provide individualized stem cell transplantations. For example, the best matching donors derived from HLA-tests will be further tested against the patient to evaluate GVHD and GVL probabilities to select the optimal donor for the specific patient.

2. The System

The invention further concerns a system for evaluating the effects of activated effector cells from the donor towards the targets cells of the recipient (patient). The system comprises a micro device with multiple wells or cell chambers, a software program for automated image analysis and a database containing patient data with empirical and/or statistical information of the clinical outcome of a specific condition, such as GVHD or GVL effects, the database being described more thoroughly below in the experimental section, example 1.7.

The micro device is used to compartmentalize or confine single cells or groups of cells wherein each well or chamber becomes a separate reaction chamber. The wells or chambers must be constructed to be able to keep the cells viable for a longer period of time, from hours to several days or weeks. Any design of the micro device (microchip) or similar device suitable for use in the present invention is included in the scope of the invention.

The software program evaluates the detected activation in each well or chamber and determines the number of active cells (the level or frequency of activated cells in the population), alternatively the level of activation of a single cell (more or less active). The activation is then compared to known patient cases and transplant outcomes in the database, or to a cut off value, to predict the risk of GVHD or chance of GVL effects. For automation of image acquisition and analysis, acquisition of the whole chip in a mosaic fashion is preferred, with discrete cell counting performed according to the following guidelines; recognition of discrete wells, evaluation of well content and registration of well coordinates. The software can detect the wells or chambers and evaluate the well content by following the image analysis steps, segmentation, feature extraction and classification. By this the software can count the number of cells of different sorts (effector or target) in each well with high precision. For example, detection of labeling dyes shows if the cells are alive or dead. In some applications, it might be of interest to measure the occurrence and/or intensity of some fluorescent probes both on effector cells and target cells. When the cells are counted using the software image analysis a statistical analysis in made to determine the frequency of activated cells (how many cells that are active compared to the whole population). Errors like target cells dying in a well by chance must be corrected for, and with a thorough statistical analysis it may be possible to use results from a well or chamber containing more than one effector cell. For each combination of donor and recipient a frequency of active cells can be determined within a confidence interval.

The database containing information about previous transplantations, their assayed level of effector cell activation and outcome regarding GVHD and GVL, is used as a reference to interpret the results retrieved from the activation assay. The reactivity of a number of individual effector cells, from a number of donors, towards target cells of the recipient is analyzed. A ratio of the number of effector cells from each donor showing reactivity towards target cells to the number of effector cells from each donor not showing reactivity towards target cells is calculated. The ratio is then compared to a previously determined set of previously determined ratios of donor-recipient pairs, wherein each of said previously determined ratios is associated with a known outcome of GVHD and/or GVL.

### 3. Uses of the Method and System

The method and system may be used for predicting GVHD or GVL effects before transplantation, and may therefore be useful in selecting appropriate donors. They may also be used for determining ongoing GVHD. The cells may be isolated/extracted from the wells or chambers for further use. Preferably the cells are allowed to proliferate before extraction. Activation of an effector cell may be determined by the method and the effector cells are left to undergo clonal expansion. The cells are then removed from the wells or chambers by any suitable method, e.g. using a micromanipulator.

The retrieved cells may be used for several applications. For example, the cells may be used in cell therapies. Cells that become activated towards tumor target cells of the patient may be extracted, expanded and introduced in to the patient. The assay may include “donor” effector cells from the patient himself, which may be identified as active towards the tumor, extracted, expanded and reintroduced in to the patient.

The cells may also be used for characterization of TCR (T-cell receptor) sequence or structure. Isolated T-cells may also be used to detect tumor specific antigens through screening of tumor antigens, or to evaluate antigenicity of specific peptide sequences. These antigens or detected antigenic peptides may then be used for development of vaccines. Any method known in the art for development of a vaccine from a known tumor antigen may be used.

The method may also be used for evaluating the effect of specific drugs on effector cell activation using clonal or polyclonal populations of effector cells. The method is performed either by adding the drug directly to the wells or chambers and detect activation and compare this activation to control, or by activating the effector cells towards tumor target cells in the wells, extracting the cells and then add a drug to the extracted cells. For example, cytostatics may be evaluated, if the tumor cells are weakened by the drug the T-cell mediated killing should increase. Another example may be adding mAbs to the wells and monitor activation of effector cells, such as NK-cells. For example, if mAbs are added against an inhibiting NK receptor the cells should become more active. The frequency of activated cells can thus be used to evaluate the efficacy of different drugs where effector cells are involved.

The method and system may also be used as a possible diagnostic tool for ascertaining T-cell or NK cell involvement in autoimmune diseases such as Multiple sclerosis (MS), Rheumatoid arthritis (RA), diabetes or SLE, or as a prognostic tool for determining the severity of said diseases. Low frequencies of active effector cells against beta cells of the patient or peptides related to MS or RA may be detected.

Briefly, the procedure is a follows:

### 1. Sample Preparation

Different conditions for optimal preparation of donor cells are used. Samples may be prepared from frozen or fresh blood or tissue samples. An example of a protocol using cells isolated from human samples is presented below.

### 1.1 NK and T Cell (Effector) Purification

Blood or a tissue sample containing lymphocytes from a human or animal is obtained and density gradient separation is used to remove red blood cells and purify the lymphocytes. The lymphocytes are further washed in isotonic buffer to remove platelets and debris as known in the art. The lymphocytes are then separated via negative or positive selection to enrich for the desired effector population (T or NK cells). Effector cells may be used directly after isolation or following a period of activation with cytokines, such as, for example, but not limited to, IL-2 or IL-15.

### 1.2 Target Cell Preparation

Blood or a tissue sample is taken from a human or animal subject, for example a patient scheduled to receive SCT. In the case of blood, the sample is separated with density gradient separation to remove red blood cells and purify lymphocytes. In the case of tissue, the sample is washed, homogenized and centrifuged in order to remove debris. The sample cells (target cells) are further washed with isotonic buffer prior to further use. In the case of GVL-effects tumor cells/tissue from the subject is used as target. In some cases cells from donor might be used in order to predict Host versus graft disease (rejection) after solid organ transplantation.

### 1.3 Donor and Recipient Cell Labeling

Effector cells, isolated as previously described, may be labeled with a fluorescent cell-permeable dye to enable their detection by optical microscopy. Isolated recipient target cells are labeled with separate dyes that allow their detection and, e.g. determination of cellular viability. Live/dead labeling is done either only on the target cell population before co-incubation with effector cells or on the whole cell population after the incubation period. Live/dead distinction can be achieved by labeling with two fluorophores, either unspecific (labeling all cells) or selective (labeling only live or only dead cells), or by using a bright-field image. Dead or dying cells may also be detected by assessing upregulation of apoptosis markers. All dyes are commercially available.

TABLE 1
Cell labelling schemes to distinguish effector cells, dead and
live target cells.¹

| | Target cells | | |
|---|---|---|---|
| Effector cells | Live | Dead | All |
| Cell tracker orange | CalceinAM | | DiD |
| (CMRA) or | | | |
| CalceinOrange | | | |
| CMRA or | CalceinAM | | Cell Trace |
| CalceinOrange | | | DDAO-SE |
| Cell tracker green | | Sytox Red | DiI |
| (CMDA) or CFSE | | | |
| CMRA | CalceinAM | Sytox Red | |
| Cell tracker blue | Acridine Orange | Ethidium Bromide | |

¹Table 1 shows examples of dye combinations that could be used for the purpose.

The fluorescent dyes shown in Table 1 are merely examples and should not be considered to be limiting for the method. The dyes used, and their respective concentrations are optimized for each individual cell type of interest so as to have no or limited adverse effects on their effector function being measured.

### 2. Cell-Cell Interaction

### 2.1 Donor and Recipient Cell Seeding and Incubation.

Recipient target cells are seeded onto a microchip by gravity, centrifugation or other means in predetermined numbers or concentrations depending on the cell type. Protocols are optimized to yield the maximum amount of wells containing a desired number of target cells. Similarly, after target cell seeding, the effector cells are seeded into the wells so as to have a maximum number of wells containing single effector cells. Following seeding, the sample is incubated under physiological or appropriate conditions allowing cell-cell interactions and effector cell mediated killing or activation. Previous studies and our own unpublished observations have shown that a single CTL can kill up to 4 target cells within 4 hours and a very active NK cell can kill up 7 target cells in about 12 hours. Although individual effector cells can be incubated together with target cells for extended periods of time, often up to several days, the present protocol has been optimized for incubation times ranging between 4 and 48 hours.

### 2.2 Microscopy Screening and Evaluation of Results

In the next step after loading and incubation of target cells and effector cells in the microchip, microscopy screening and image analysis are used to evaluate the outcome of cell interaction and lytic activity. The following is a brief overview of this process.

Basically, this method relies on selective detection and characterization of effector cells and target cells following incubation. This can be achieved by, but is not limited to, selective fluorescence labeling according to Table I, or by monitoring cell size or morphology.

Accordingly, cellular activation may, for example, be detected by labeling specific proteins up-regulated on the effector cell surface during or after the incubation period by using fluorescently tagged antibodies. Alternatively, cellular activation may be detected by assessing upregulation of activation markers or cytokines, e.g. the up-regulation or secretion of lymphokines. Another read-out may be detection of an immune synapse, where a special case is the CD4 T cell synapse that does not lead to target cell death but has signatures that could be detected by fluorescence microscopy, e.g: clustering of TCR or MHC 1 at intercellular contact. Alternatively, activation may be detected as increased effector cell proliferation following the co-incubation period. Screening and detection of cells may be achieved with e.g. an optical microscope or similar for detecting transmitted light and/or fluorescence images.

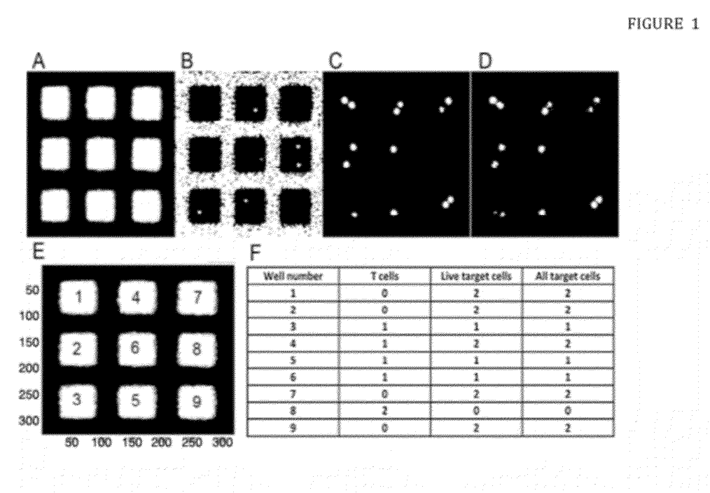

In the present invention, the numbers of live and dead target cells, as well as the number of effector cells, are detected and evaluated in each well by the use of an automated image analysis software program. Live/dead cell ratios are assigned to each well. Thus, with this information the spontaneous level of target cell death may be quantified by analyzing wells containing no effector cells; and the level or effector cell mediated killing may be quantified by analyzing the results in wells occupied by both effector cells and target cells as shown in FIG. 1.

### 3. Database and Empirical Analysis

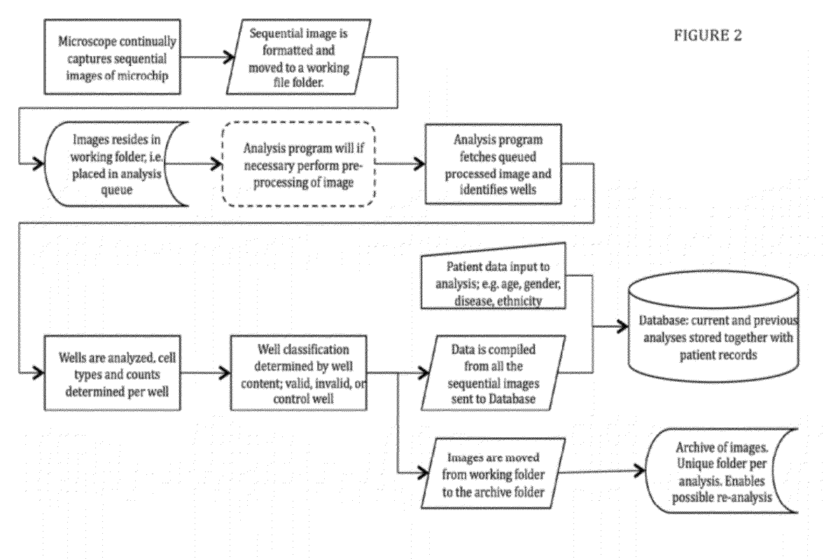

As depicted in FIG. 2, the data generated by optical microscopy screening is analyzed by software for image analysis and is compared with patient data stored in an accumulated database containing empirical and clinical information on donor-recipient screening results, clinical outcome, etc. Thus, one will know with accuracy and within a couple of days which clinical outcome to expect with regard to GVHD or GVL after transplantation.

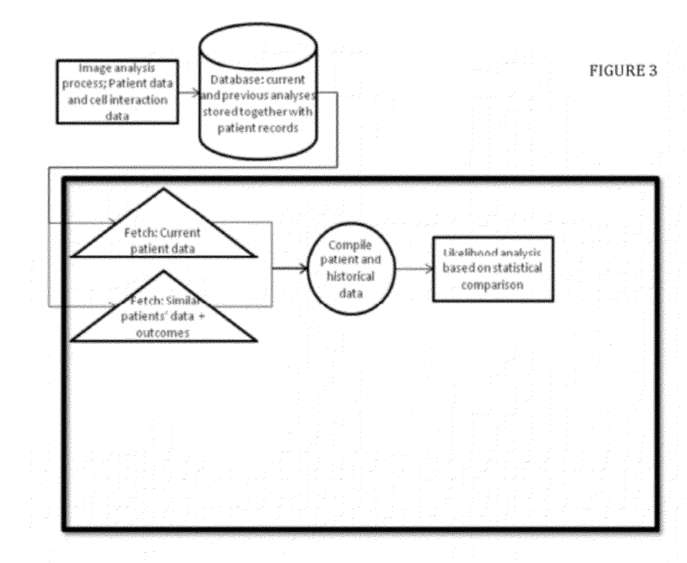

The comprehensive database of this disclosure is created as illustrated in FIG. 3, namely by performing a large number of compatibility screens between donors and recipients according to the disclosed method. In the database, empirical data is grouped and correlated with a great number of clinical parameters from both donors and recipients. Donor's parameters included are gender, age, stem cell source, ethnicity, sero-status of viruses, disease indication, etc. Patient's or recipient clinical parameters that might be included in the database are genus, ethnicity, stem cell dose, age before transplantation, grade of MHC-mismatch and the post transplantation outcome like GVHD, rejection, relapse of the malignant disease, among others.

This collection of both clinical and empirical data is indispensable for setting up reference points for the prediction of GVHD and GVL in correlation with the empirical data for every single patient. This approach of universally collecting all empirical data from different patients and donors in the same database is novel and provides powerful new information to support SCT clinicians in their decisions. Further, it differs from previous approaches to predict GVHD and/or GVL, where only small subgroups within single center studies are collected and equaled.

### 4. Description of the Microchip

Once the effector and target cells are isolated, purified and labeled according to steps 1.1 to 1.3, they are subsequently loaded in the microchip of the invention for separation and further investigation. Accordingly, the next paragraphs relate to another embodiment of the present invention, namely the specially designed multi-well micro device of the present invention and the major features employed in the same. However, any microchip or cell chamber in which the cells remain viable is suitable for use in the method of the present invention, and is thus included in the scope of the invention.

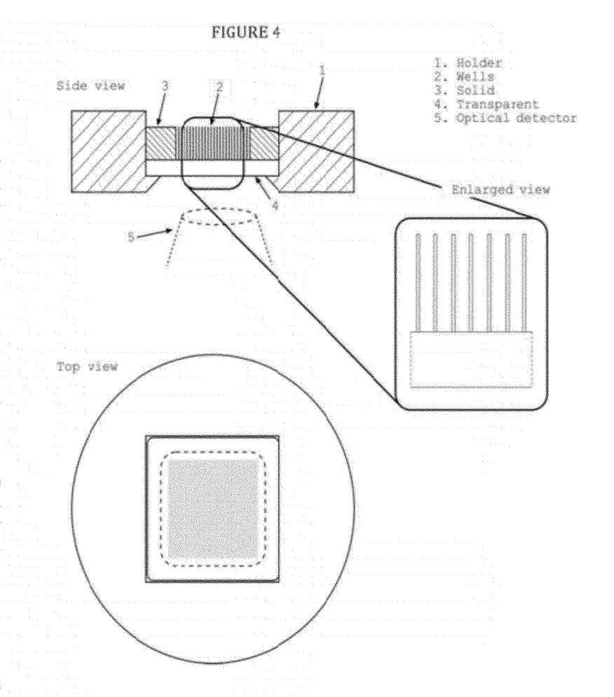

As illustrated in FIG. 4, the microchip contains multiple miniature wells, niches, cavities or compartments allowing cell-cell interactions laid out in any array format, preferably on a substrate compatible with optical microscopy. In the example chip, the wells have a square shape and are etched in silicon and bonded to a glass substrate. Silicon and glass are suitable materials as the system is open to the surrounding air and kept under standard atmospheric pressure. With hydrophobic materials such as PDMS, cleaning, liquid priming, cell loading and liquid exchange become problematic, requiring additional surface modification protocols or pressurized delivery of liquids. Silicon and glass being hydrophilic, no further means are needed for liquid handling with the chip.

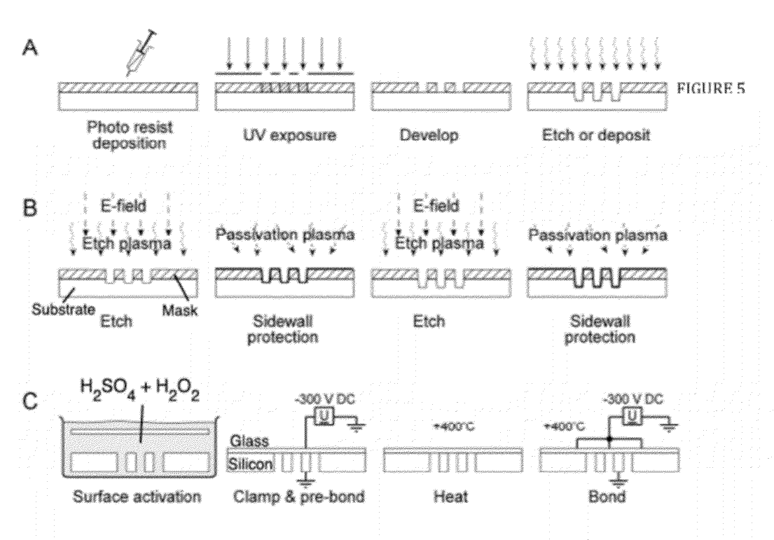

Previous systems have often included a microscope glass slide as the transparent lid or bottom on to which cells are sedimented. This is unsuitable in high magnification, high-resolution microscopy where the optical path has to be well controlled, both when it comes to material choice (transparency in desired wavelengths) as well as the actual length (glass thickness) between the main lens surface and the cells to be imaged. Our investigations have shown that a suitable glass thickness is 170 μm (+/−5 μm) and the glass composition should contain low levels of alkali metals. There are different methods for manufacturing silicon-glass microchips. FIG. 5 shows the main steps of three of these methods: photolithography, deep etching and anodic bonding. However, this application is not limited to any material, shape or layout of the wells, niches or compartments, or method for their manufacture.

As the wells are open to the surrounding air, the system allows gas and liquid exchange in the wells. This allows long-time survival of the cells, as it is simple to exchange cell media or add, e.g. fluorescent dyes or chemicals for drug testing. Cells may be allowed to proliferate in the wells of the chip, as a signal of activation or for increasing the probability for successful isolation of a clone from the wells. The wells have thin, vertical walls to optimize the number of wells for high throughput applications.

The well depth has been adjusted to strongly limit the probability of cells escaping from one well to another during culture, incubation or imaging. The well depth is however limited to sub-millimetre range in order to encompass an efficient transport of gases and nutrients to the cells, as well as transport of residuals from the cells, through convective flux, marangoni flow and molecular diffusion.

By using thin and vertical walls the well density has been maximized, thus improving the optical assay and loading efficiency for high throughput applications. Other micro devices in the field encompass conical or funnel-shaped wells, yielding a decreased number of wells, and thus a low number of cells assayed simultaneously. These devices also have a lower cell count per unit area, making the assay less efficient as compared to the design of the invention herein. It should also be appreciated that the chip loading procedure through dropping cells in suspension onto the chip is considerably simpler than setting up single cell deposition systems such as FACS.

### 5. Preferred Embodiments

The system and the methods hereby disclosed have been optimized to allow GVHD and GVL prediction prior to SCT, but while not limited to this listing further applications include:
Use of specific clonal populations of T cells to detect tumor specific antigen, or as effector cells to evaluate antigenicity of specific peptide sequences, e.g. to be used for development of vaccines.
Use of specific clonal populations of effector cells as cell therapy, e.g. against various forms of cancer.
Evaluation of the effect of specific drugs, e.g. monoclonal antibodies, on killing efficiency of individual effector cells within larger populations.
Diagnostic tool for ascertaining the presence of hard-determined gastrointestinal or other sorts of GVHD.
Diagnostic tool for ascertaining T cell or NK cell involvement in autoimmune diseases.
Prognostic tool for determining the severity of T cell or NK cell mediated diseases in patients, e.g. autoimmune diseases such as SLE or MS.
Prognostic tool for prediction of Host versus graft disease (rejection) after solid organ transplantation.

As to a further discussion of the manner of Usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The invention is described in detail below. The examples and experimental details are disclosed to provide an improved understanding and guidance for those skilled in the art.

### DETAILED DESCRIPTION OF THE DRAWINGS

FIG. 1 illustrates the automated detection and screening of effector cells, all target cells and living target cells. A is an image of grid structure; B is a fluorescence image of T cells; C is the fluorescence image of living target cells; D refers to the fluorescence image of all target cells; E shows the automated detection of wells, wherein each well has been assigned a number as indicated and F is a table showing the number of cells detected in each well.

FIG. 2 is a flow-chart depicting the process for image analysis. A microscope continually captures sequential images of the microchip. A sequential image is formatted and moved to a working file folder. The image resides in the folder, i.e. placed in an analysis queue. The analysis program fetches the queued processed image and identifies the wells. Through image segmentation cells and their corresponding wells are identified. The content of each well is evaluated and specific features, e.g. color, shape and size, are extracted from detected objects, which are then classified. Each well on the current image receives a unique address. The number of cells of each type in each well is counted and data is recorded accordingly. The well classification is determined by well content. In the simplest case, wells are considered valid if they contain one effector cell and 1+target cells, i.e. more than one target cell, as control if it contains 1+target cells or invalid if it contains any other combination of cells. The process is repeated until the microchip has been covered. Data is then compiled from all the sequential images and sent to the database. Patient data is also put into the analysis, such as gender, age, diseases and ethnicity. The database stores current and previous analyses together with patient records. The images are removed from the working folder and moved to an archive folder. The archive is composed of unique folders, one for each analysis, which enables re-analysis if desired.

FIG. 3 is a schematic representation of the process for predicting GVHD/GVL outcome using the accumulated database with clinical and empirical data. The image analysis process is carried out and patient data and cell interaction data are added to the database, which stores the current analysis and previous analyses together with patient records. The current patient data is fetched from the database, as well as data for similar patients and their respective outcomes regarding GVHD or GVL after transplantation. Patient data and historical data are compiled, and a likelihood analysis for predicting GVHD or GVL after transplantation is performed based on statistical comparison.

FIG. 4 is a partial schematic diagram illustrating a potential embodiment of a design of the microchip. From a side view the chip comprises a holder (1), wells (2) with solid surrounding edges (3) and a transparent bottom (4) through which the optical detector (5) may detect the labeled cells. A detector may also be placed above the wells, such as a bright-field detector. The figure also contains a drawing of the chip seen from above, a top view, and an enlarged side view of the wells and the transparent bottom.

FIG. 5 shows the sequence of steps in three different methods for the manufacture of silicon-glass microchips: A. Photolithography. Photo resist deposition is followed by UV exposure, development and etching or deposition. B. Deep etching. Etching using an electrical field and etch plasma is alternated with sidewall protection using passivation plasma. The etching is repeated once more, as well as the sidewall protection. C. Anodic bonding. The surface is activated using sulfuric acid and water, clamp and pre-bonding of the glass and silicon material is made using a voltage of 300V. The material is heated to +400° C. and kept at that temperature during bonding using a voltage of 300V.

### EXAMPLES

### Example 1

### Screen for Alloreactive Cells

In order to obtain a proof of concept, the donor and recipient cells used were miss-matched in 3 out 6 major HLA alleles (considering HLA-A, HLA-B and DRBI). This is a higher degree of miss-match compared to the real transplantation setting where seldom more than 1 miss-matched major HLA allele is allowed. The advantage in using a higher degree of miss-match for this experimental setup is that the frequency of reactive T cells will be much higher facilitating the detection and quantification of these specific killing T cells.

### 1. Effector Cell Preparation.

To obtain T cells, 20 ml of peripheral blood was drawn in two 10 ml heparinized collection tubes. Blood was diluted 1:1 in phosphate-buffered saline (PBS) prior to a 20 min separation of peripheral blood mononuclear cells (PBMCs) by Ficoll density gradient centrifugation at 400 g without brakes. The PBMCs were collected and washed by diluting in PBS and centrifugation for 10 min at 400 g force. The supernatant was discarded and washed in 50 ml PBS as described previously.

PBMCs viability was assessed with trepan blue prior to labeling with a biotinylated antibody cocktail (Pan T cell isolation kit II®, Miltenyi Biotec) for 15 min at 4° C. The sample was washed as previously, the cell pellet was diluted in PBS and cells were labeled with paramagnetic anti-biotin beads (Pan T-cell isolation kit II®, Milteneyi Biotec) for 10 min at 4° C. Cells were washed twice in PBS before negative selection on LS-columns (Miltenyi Biotec) attached to a strong magnet. Labeled cells are trapped within the column while the unlabeled T cells of interest are collected with 2×3 ml of PBS. T cells were washed and an aliquot was labeled with FITC-conjugated anti-CD3 antibody to check the purity (>95%). Remaining T cells were frozen in complete medium containing 10% DMSO and 10% fetal calf serum (FCS) at −123° C. When required, T cells were thawed, washed in PBS and counted with trepan blue to assess viability.

### 2. Target Cell Preparation.

The THP1 cell line (Human acute monocytic leukemia) was purchased from ATTC (ATTC No. TIB-202) and grown in suspension; RPMI 1640+10% FBS, 2 mM L-Glutamine, 1 mM sodium pyruvate, and 100 units/ml penicillin/streptomycin. Cultures were maintained between 2-9×10⁵ cells/ml at 37° C., 5% CO₂.

### 3. Cell Staining.

Purified effector T cells and target THP1 cells were centrifuged separately at 300 g to pellet the cells. Effector cells were stained in 37° C. RPMI 1640+1 μM Calcein Red Orange-AM while target cells were stained in 37° C. RPMI 1640+5 μM Celltrace Far Red DDAO-SE+1 μM Calcein-AM at 37° C., 5% CO₂ for 10 minutes. After staining, cells were washed twice with 14 ml of pre-heated (37° C.) RPMI and resuspended at 200,000 cells/ml.

### 4. Cell Seeding.

The microchip of the invention was gently placed in the custom-built holder and 1 ml of dye-labeled THP1 target cells was placed onto the microchip. Cells were allowed to settle under the effect of gravity until a desirable concentration was reached (˜15 minutes). The microchip was rinsed gently 5 times with 1 ml of pre-heated (37° C.) RPMI 1640 to remove cells which were not trapped in the wells. The effector cells were subsequently seeded identically to the target cells. Effector cells not trapped in wells were washed away by gently rinsing the 5 times with 1 ml of pre-heated (37° C.) RPMI 1640. Finally, 2 ml of RPMI 1640 media containing 10% FBS. 2 mM L-Glutamine, 1 mM sodium pyruvate, 1×non-essential amino acids, and 100 units/ml penicillin/streptomycin was placed on the microchip.

### 5. Microscope Screening

The microscope holder containing the cell-loaded microchip was placed on a laser scanning confocal microscope (Zeiss Pascal). Imaging was performed using a 10× objective and to avoid cross-talk between emission spectra from different fluorophores, images were scanned sequentially. The excitation energy and photomultiplier gain was optimized for each channel to have an optimal signal to noise ratio. A tile scan was performed to image the entirety of the microchip. After scanning, the chip was gently removed from the holder and placed in warm RPMI 1640 media containing 10% FBS, 2 mM L-Glutamine, 1 mM sodium pyruvate, 1×non-essential amino acids, and 100 units/ml penicillin/streptomycin overnight at 37° C., 5% CO₂. After 24 hours, the microchip was replaced in the holder, covered with 1 ml of pre-heated medium and new images were obtained as described above.

### 6. Image Analysis.

The individual images comprised of a bright-field image, a fluorescence image of effector cells (Calcein Red Orange-AM), a fluorescence image of live target cells (Calcein-AM) and a fluorescence image of all target cells (Celltrace Far Red DDAO) were opened using the ImageJ software (National Institutes of Health, USA). In this software a 1×1 median filter was applied and image brightness and contrast changed to optimize detection of cells in the fluorescence images and outline of microwells in the bright-field image. The individual files were converted to tagged image file format (TIFF). Minor overlap errors in the mosaic images caused by inherent limitations of the moving stage and objective magnification were corrected using home-developed routines in Matlab (MathWorks, Natick, Mass., USA). The corrected images were broken into smaller sections and exported for analysis by CellProfiler (Broad Institute, MIT and Harvard, Massachusetts, USA). In CellProfiler pipelines were created to detect individual wells and count the number of fluorescent effector cells, the total number of target cells and the number of living target cells inside each well. This may also be done using Matlab or other software. For evaluation, the results from automatic counting could be exported and summarized in spreadsheets (Excel, Microsoft Office), or this step may be included in the specially adapted software program. Thus, the spontaneous level of target cell death may be quantified by analyzing wells containing no effector cells, while the level of effector cell mediated killing (or other forms of activation) is quantified in wells occupied by both effector cells and target cells.

### 7. Database and Empirical Analysis

In order to draw a conclusion from the analysis of the cell interactions in the micro device, a reference is needed. There are several recognized parameters, which influence the immuno-compatibility between individuals. In the case for ASCT, the primary parameters (for patient and donor), which empirically have been shown to affect outcome for the patient, are: HLA-match, ethnicity, gender, blood type, age and disease history. A database is created which stores information about performed ASCT procedures. Information that is stored is primarily the mentioned parameters for patient and donor, outcome of procedure and the disclosed pre-transplantation analysis. Patient materials from earlier transplantations, in which information about GVHD outcome have been stored, are analyzed using the method to get information to build up the database. Experimental results together with transplantation outcomes are stored to get a connection between analysis results and actual outcome of the transplantations. The patient-donor matching for the current analysis is compared with previous analyses in the database. Thus, the results of previous patient-donor pairs are used as a reference for the current analysis. When performing a new analysis using the method of the present invention, the results (quantity of activated effector cells) together with data about the donor and recipient (patient) is compared to the information in the database and a prediction of the outcome is made. Based upon the prediction of possible GVHD or GVL effects a suitable donor may be chosen for the present patient.

A statistical comparison is performed between the aggregate specificity of the current analysis and the comparable data set from the database. The output of the analysis provides the statistical probability of e.g. GVHD or GVL for an ASCT procedure. Ideally, a cut off value may be calculated using the database, where analysis results for a donor below the cut off value are considered suitable for transplantation, whereas results above the cut off value are considered to be associated with a high risk of GVHD.

For the ASCT patient-donor database, the patient-donor information in the database need not be traceable to the patient and donor identities. The relevant information about the patient is gathered at the clinic performing the ASCT procedure for the patient. The relevant information about donor is available from the HLA register, which has located donor candidates. Legal consent, where necessary, to store information is obtained from patient and donor. The database is intended to be continuously growing in data.

### Example 2

This example illustrates the steps that follow example 1, where identified specific T-cells from analysis are desired to be isolated, expanded and injected into a patient, e.g. In the case of cell therapy.

### 8. T Cell Harvesting.

After analysis, wells with specific cytotoxic T-cells will have been identified. Without damaging the T-cells, these are extracted from their respective wells. For increasing chance of success and cell survival when isolating the T-cells, the cells may be left in the wells to proliferate for some time before extraction. Examples of harvesting methods are by optical or acoustic traps or by magnetic labeling and extraction as known in the art, such as a micromanipulator.

### 9. T Cell Expansion

The specific effector cells are transferred to culture flasks containing RPMI-medium with added L-glutamine, streptomycin, penicillin, 10% human AB sera and recombinant IL-2. In order to stimulate growth of the effector T-cells, magnetic beads coupled to stimulatory antibodies against CD3 and CD28 are added. The cells are cultured at 37° C., 5% CO₂ for 8 days. T-cells are then analysed, functionally tested against the same cells as in the screening procedure and tested for microbial and viral contaminations.

### 10. T-Cell Injection

Effector T-cells are extensively washed in NaCl-solution before concentration via centrifugation. Cells are resuspended in a NaCl-solution containing 10% human AB sera and taken up in a 20 ml heparinized syringe. The syringe is given to the responsible physician who injects the cells intravenously into the arm or a central-catheter in the patient.

### Example 3

### 11. Microchip Design Criteria and Considerations

When designing the chip dimensions one should consider different aspects such as to maximize the cellular interactions, to be able to contain sufficient nutrients, deep enough to prevent escape or movement of the cells between wells and biocompatibility; optimization of the washing steps.

The microchip enabling the present invention should meet specific design requirements as follows:

Medical or Statistical Demands
useful number of cells, range 10⁴ to 1.5×10⁶
yield after seeding, range 25% to 85%
plausible number of positive cell-cell interactions, range 2/10 000 to 100/10 000

Optical Demands
transparency, range from IR over optical visibility to UV
optical path, range from 150 μm to 200 μm
flatness, range max +/−0.1 μm

Biological Demands
biocompatibility, range max 3 weeks cell survival
well depths for capturing, range 100 μm to 1 mm, resulting in sedimentation time 10 min
avoid escape, range 100 μm to 1 mm, enabling assays with “levitating” non-sedimenting cells

Loading and Seeding Demands
thin walls to minimize the number of cells on walls between wells, range 5 μm to 100 μm
densely spaced wells in high numbers enables single droplet deposition of cells in suspension, thus simplifying chip loading, range 10 k to 300 k wells per chip

Imaging Demands
flatness over whole chip for sharp pictures, range max +/−2 μm
Region of interest area, single well image up to full chip image, range 20 μm×20 μm to 20 mm×20 mm imageable area per picture. Technological progress within imaging may change future parameters.

### REFERENCES

1. J. Nilsson, M. Evander, B. Hammarström, Laurell Analytica Chimica Acta 649 (2009) 141-157.
2. B. M. Taff, J. Voldman, Anal. Chem. 77 (2005) 7976.
3. T Schnelle, R Hagedorn, G Fuhr, S Fiedler, and T Müller. 1993.
4. Skelley A M, Kirak O, Suh H, Jaenisch R, Voldman J. Microfluidic control of cell pairing and fusion. Nature methods, 2009 February; 6(2): 147-52.
5. S. Zheng, H. Lin, J. Q. Liu, M. Balic, R. Datar, R. J. Cote, Y. C. Tai, Membrane microfilter device for selective capture, electrolysis and genomic analysis of human circulating tumor cells, in: 21st International Symposium on Miroscale Bioseparations, Elsevier Science BV. Vancouver, Canada, (2007) 154,
6. W. H. Tan, S. Takeuchi, Proc. Natl. Acad. Sci. U.S.A. 104 (2007) 1146.
7. Retting, J. R., Folch, A., 2005. Anal. Chem. 77, 5628-5634
8. Wei C H, Yagita H, Masucci M G, Levitsky V. Different programs of activation-induced cell death are triggered in mature activated CTL by immunogenic and partially agonistic peptide ligands. J Immunol. 2001 Jan. 15; 166 (2):989-95.
9. Lovgren J, Blomberg K. Simultaneous measurement of NK cell cytotoxicity against two target cell lines labelled with fluorescent lanthanide chelates. J Immunol Methods. 1994 Jul. 12; 173(1):119-25.
10. Mack A, Furmann C, Hacker G. Detection of caspase-activation in intact lymphoid cells using standard caspase substrates and inhibitors. J Immunol Methods. 2000 Jul. 31; 241(1-2):19-31.
11. Cui J, Bystryn J C. An improved europium release assay for complement-mediated cytolysis. J Immunol Methods. 1992 Feb. 14; 147(1):13-9.
12. Shata M T, Barrett A, Shire N J, Abdelwahab S F, Sobhy M, Daef E, et al. Characterization of hepatitis E-specific cell-mediated immune response using IFN-gamma ELISPOT assay. J Immunol Methods. 2007 Dec. 1; 328(1-2):152-61.
13. Uhlin M, Masucci M G, Levitsky V. Regulation of lck degradation and refractory state in CD8+ cytotoxic T lymphocytes. Proc Natl Acad Sci USA. 2005 Jun. 28; 102(26):9264-9.
14. Vahlne G, Becker S, Brodin P, Johansson M H. IFN-gamma production and degranulation are differentially regulated in response to stimulation in murine natural killer cells. Scand J Immunol. 2008 January; 67(1):1-11.
15. Mueller S N, Jones C M, Smith C M, Heath W R, Carbone F R. Rapid cytotoxic T lymphocyte activation occurs in the draining lymph nodes after cutaneous herpes simplex virus infection as a result of early antigen presentation and not the presence of virus. J Exp Med. 2002 Mar. 4: 195(5):651-6.
16. Rasmusson I, Uhlin M, Le Blanc K, Levitsky V. Mesenchymal stem cells fail to trigger effector functions of cytotoxic T lymphocytes. J Leukoc Biol. 2007 October; 82(4):887-93.
17. Miura Y, Thoburn C J, Bright E C, Hess A D. Cytolytic effector mechanisms and gene expression in autologous graft-versus-host disease: distinct roles of perforin and Fas ligand. Biol Blood Marrow Transplant. 2004 March; 10(3):156-70.

1-19. (canceled)

20. A method for analyzing activity of effector cells from a donor based on effector cell interaction with target cells of a recipient comprising:
a. isolating effector cells from the donor and target cells from the recipient;
b. distributing said cells to a number of micro-wells, such that an amount of the micro-wells comprises at least one effector cell and at least one target cell;
c. incubating the cells; and
d. analyzing activity of the effector cells by measuring at least one of the following effector functions:
i) lysis of target cells;
ii) upregulation of activation markers in the effector cells;
iii) upregulation of cytokines in effector cell(s);
iv) stable cell-cell contact between effector cell(s) and target cell(s); and
v) proliferation of the effector cell(s);

21. The method according to claim 20, wherein the number of micro-wells is more than 1,000.

22. The method according to claim 20, wherein the cells are distributed to the micro-wells so that a maximum number of the micro-wells contains 1-2 effector cells and 1-5 target cells.

23. The method according to claim 20, wherein the analysis in step d is done by optical microscopy, radioactivity, or scanning probe technology.

24. The method according to claim 20, wherein the method is for predicting or determining GVHD or GVL effects in connection with transplantation by analyzing reactivity of effector cells of the donor towards target cells of the recipient.

25. The method according to claim 24, wherein the effector cells are T cells and/or NK cells.

26. The method according to claim 25, wherein the effector cells and/or the target cells are fluorescently labeled before or after the incubation in step c.

27. The method according to claim 26, wherein the reactivity of effector cells is analyzed by measuring the number of effector cells, the number of live target cells and the number of lysed target cells by fluorescence microscopy.

28. The method according to claim 20, wherein the method is for isolating effector cells activated based on effector cell interaction with target cells, and further comprises:
a. optionally allowing for clonal expansion of the effector cells in the micro-wells; and
b. removing activated effector cells from the micro-wells, by using a micromanipulator.

29. The method according to claim 28, further comprising using effector cells obtained by the method in cell therapy and/or for characterization of TCR sequence or structure.

30. The method according to claim 28, further comprising using effector cells obtained by the method which are T cells to detect tumor specific antigens and/or to evaluate antigenicity of specific peptide sequences.

31. A method for selecting a donor of cells to a recipient of cells, comprising the steps:
a. analyzing activity of a number of individual effector cells of a number of donors towards target cells of the recipient;
b. calculating a ratio of the number of effector cells from each donor showing activity towards target cells to the number of effector cells from each donor not showing activity towards target cells;
c. comparing said ratio(s) to a predetermined set of predetermined ratios of donor-recipient pairs, wherein each of said predetermined ratios is associated with a known outcome of GVHD and/or GVL; and
d. selecting a donor from which cells have a ratio close to a predetermined ratio associated with a desired outcome of GVHD and/or GVL.

32. A system for analyzing activity of effector cells from a donor based on effector cell interaction with target cells from a recipient, the system comprising:
a. a micro-device with multiple wells;
b. a software program for automated image analysis; and
c. a database containing patient data with empirical and/or statistical information of clinical outcome of a specific condition.

33. The system according to claim 32, wherein the micro-device comprises more than 1,000 wells.

34. The system according to claim 32, wherein the software program is specially adapted to determine the number of effector cells that show activity due to effector cell interaction with the target cells and/or the number of wells which contain such activated effector cells.

35. The system according to claim 32, wherein the software program is specially adapted to quantify the activity of effector cells due to effector cell interaction with the target cells.

36. The system according claim 32, wherein the database comprises a predetermined set of predetermined ratios of donor-recipient pairs, wherein each of said predetermined ratios is associated with a known outcome of the specific condition(s) GVHD and/or GVL.

37. The system according to claim 32, wherein the database provides a cut off value, which indicates the number of activated effector cells that is significant for the specific condition(s).

38. A method for evaluating the effect of a drug on effector cell activation comprising:
a. isolating effector cells from the donor and target cells from the recipient;
b. distributing said cells to a number of micro-wells, such that an amount of the micro-wells comprises at least one effector cell and sat least one target cell;
c. incubating the cells; and
d. analyzing activity of the effector cells by measuring at least one of the following effector functions:
i) lysis of target cells;
ii) upregulation of activation markers in the effector cells;
iii) upregulation of cytokines in effector cell(s);
iv) stable cell-cell contacts; and
v) proliferation of the effector cell(s);
wherein the drug to be evaluated is added to micro-wells before or after step b, and comparing the activity of effector cells in the presence and absence of the drug.
